(19) United States
(12) Patent Application Publication
(10) Pub. No.: US 2014/0103817 A1
(43) Pub. Date: Apr. 17, 2014

(54) Night light

(71) Applicant: Jimmy Darl Wantiez, Okmulgee, OK (US)

(72) Inventor: Jimmy Darl Wantiez, Okmulgee, OK (US)

(21) Appl. No.: 13/573,962

(22) Filed: Oct. 17, 2012

(51) Int. Cl. H05B 37/02

(52) U.S. Cl. CPC H05B 37/02
USPC 315/159

(57) ABSTRACT

A night light is made to operate conveniently from a house current by converting the current to lower voltage for efficient automatic operation of a suitable LED light, or other suitable small light, for response to ambient light. An almost instantaneous response to an ambient light is provided by a circuit formed of readily available standard components guided in this instance by cooperation of a photocell which responds to a light ray to direct a Schmitt-trigger Inverter to operate a super-bright LED lamp. Circuitry is placed upon a printed circuit board upon a plastic housing for safety and convenience.

### BACKGROUND OF THE INVENTION

1. Field Of The Invention

I have invented and developed a night light to operate conveniently from a house current to a lower voltage and to provide proper automatic operation of an LED light unit, or other small light, which will therefore respond to a prevalent indication of ambient light. An almost instantaneous response to a change in ambient light is provided by a circuit I have developed which is comprised of components which are readily available today, and greatly enhance the operating convenience of a night light.

As I describe hereafter, I have included various sensor components which will react almost instantaneously to ambient light to provide proper control of the condition of the night light. To the operator of the night light the reaction to the condition of the ambient light appears instantaneous, and, therefore, I feel I am describing the switching properly when I refer to it as instantaneous.

2. Description of the Prior Art

I had a patent search conducted of my invention, and the following patents were considered to be the most pertinent:

| | | |
|---|---|---|
| 6,022,128 | James Chi | Feb. 8, 2000 |
| 6,390,647 | Louisa Shaefer | May 21, 2002 |
| 2002/0075677 | Hans Dokoupil | Jun. 20, 2002 |
| 2006/0007709 | Se Kit Yuen | Jan. 12, 2006 |
| 7,784,992 | Ron Gustaveson | Aug. 31, 2010 |
| 7,828,463 | Anton Michael Willis | Nov. 9, 2010 |
| 7,874,717 | Louisa Shaefer | Jan. 25, 2011 |
| 8,040,102 | Ching-Shang Kao et al | Oct. 18, 2011 |
| 8,132,938 | Claes Goran Granqvist | Mar. 13, 2012 |

Chi, U.S. Pat. No. 6,022,128, describes a night light adaptable for a household circuit, wherein a lamp holder includes a semi-transparent obstructing plate, and the front of the lamp has a light sensitive resistor which automatically responds to outside light, in connection with a cylinder which provides a contact point to permit suitable positioning of the lamp components.

Shaefer, U.S. Pat. No. 6,390,647, shows a night light adaptable for either indoor or outdoor use, to provide various brightness levels, responsive to ambient light, and being capable to adjust to specific levels.

Dokoupil, 2002/0075677, shows a night light including a circuit limiting capacitor mounted on a circuit board and made adaptable to provide a small amount of energy in value of around 0.03.W.

Yuen, 2006/0007709, describes a night light for household use comprising; a transparent front panel with an ability to focus all angles of light in form of an optical sphere along with means of a cold-cathode light source.

Gustaveson, U.S. Pat. No. 7,784,992, shows a night light comprising a solar panel on outside of circuit which includes a battery which is chargeable by the solar panel. Control circuitry connects battery, solar panel, LED light, and a photocell. The photocell responds to ambient light, during daylight charging the battery, while during night time translucent lenses are illuminated.

Willis, U.S. Pat. No. 7,828,463, shows a street light that includes controls to modulate lighting so that artificial illumination is reduced when the desired moonlight is available.

Shaefer, U.S. Pat. No. 7,874,717, shows a night light adaptable for inside and outside use. Several designs include light sensing element and control circuit, all responsive to ambient light. Light provides for variable control wherein brightness of light can be continuously varied between very dim and fully bright.

Kao, et al, U.S. Pat. No. 8,040,102, shows a solar-powered LED street light including a charge controller, means for converting power in a battery, a switch power supply, and power cable data communicating unit.

Granqvist, U.S. Pat. No. 8,132,938, illustrates an illumination system in which an area within a building comprises an area having controllable transmittance, and includes elements for providing a balanced illumination.

### OBJECTS OF THE INVENTION

The primary object of my invention is to provide a night light which is small and easy to handle, and easy to assemble after it is purchased by the average buyer, so that it may be quickly assembled by reading a few simple directions. As a result of its simplicity, the various components should be easily available for widespread distribution by any distributor for safe and convenient storage for the eventual purchaser to see and understand.

The simplicity of my invention should be more evident and particularly appreciated by the user because my night light is responsive to ambient light, as at dawn and dusk, but, especially because it is made to respond very quickly to the ambient light, which should be greatly appreciated by the user.

I have designed and developed my invention for the purpose of providing a night light that is composed of standard electronic components that are readily available on the market, and which may be easily and quickly assembled upon a small PC board to be sturdily assembled into a plastic housing for safe and easy handling. The chosen components are long-lasting, and the most important component of my invention is the inclusion of a Schmitt-trigger Inverter to provide an instantaneous switching reaction for the convenience of the user.

The circuitry responds to the ambient light, and, when dusk and dawn reach the pertinent values, the on/off switching is obviously an instantaneous action and the user greatly appreciates this condition.

### SUMMARY OF THE INVENTION

In researching, and eventually developing my invention, I prepared a prototype, which I exhibit in FIG. 2, in which I identify the various components as in current terminology.

I finally achieved the structure I had in mind when I was able to construct a night light which would overcome certain known problems and also provide a circuitry which would prevent other anticipated possibilities.

For example, and most importantly, I want a night light which was safe and easy to handle, produce a bright light, instantaneously upon being turned on, and include special safety for a malfunction.

With careful planning and testing, I have chosen the present combination of components to be the most suitable for my operation. I have chosen standard components which are readily available and which could be easily assembled within a small plastic containing member in a manner that the bright night distributes the light in the most effective direction. I have placed a light-receiving photocell at a convenient position at what I considered the most advantageous reception of light, and, most importantly, I have included an instantaneous switching component in circuit with the photocell to provide the lighting device with rapid, theoretically instantaneous, action of the switching means for safety of the person using the night light. Also, within the electrical circuit I have placed a fuse component to provide a form of protection for the device.

### BRIEF DESCRIPTION OF THE DRAWINGS

FIG. 1 is a perspective view of a night light according to my invention.

FIG. 2 is a schematic view of a night light according to my invention describing the various components in their connections.

FIG. 3 is a schematic view of a night light according to my invention indicating the electrical description of each component.

### DETAILED DESCRIPTION OF A PREFERRED EMBODIMENT

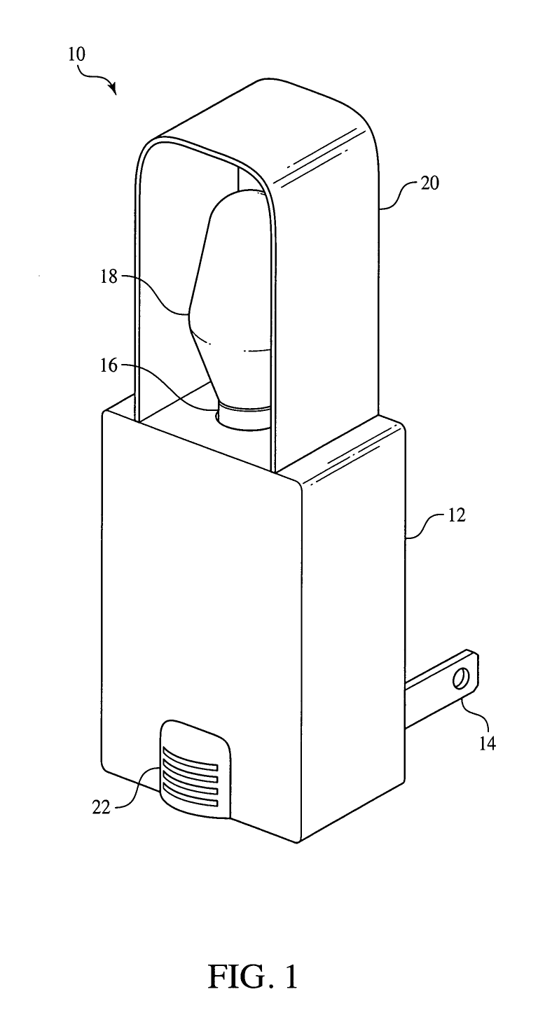

I have prepared an initial view of my night light in the perspective view of FIG. 1 showing my night light 10 as it would be ready for installation of use.

Night light 10 comprises a main body unit 12 provided with plug in members 14 which make my night light adaptable for use on a household circuit.

I have provided a socket 16 to receive a typical LED light 18 for which I have provided a lamp housing 20.

At the most convenient position of body unit 12 I have positioned a photocell component 22.

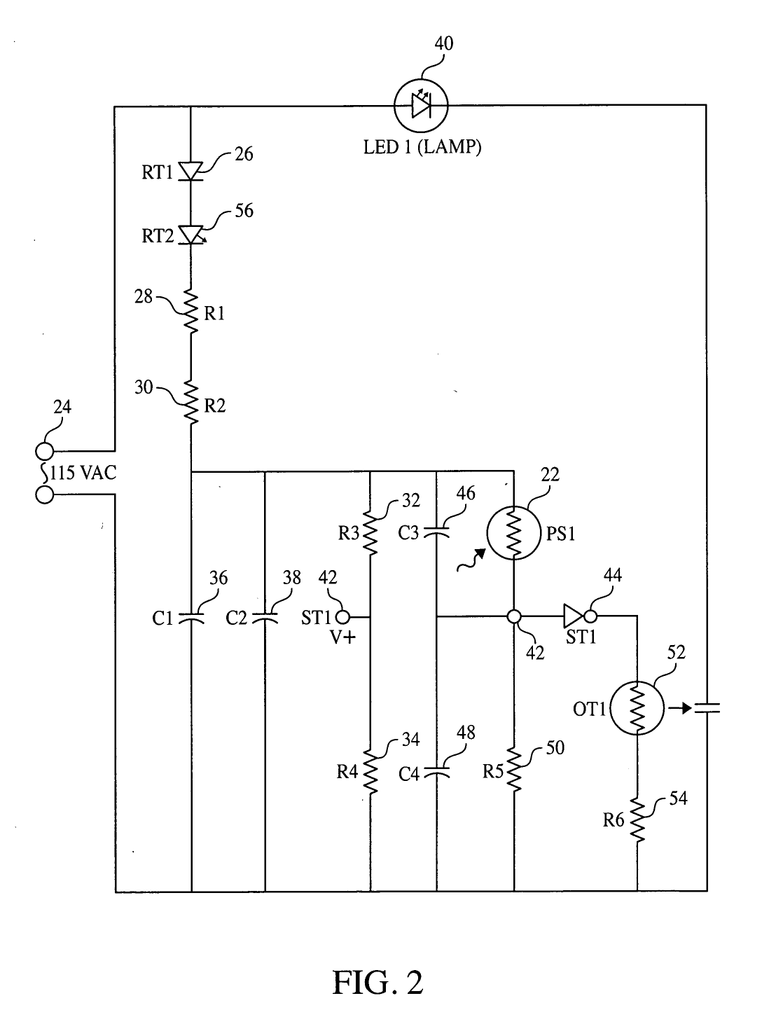

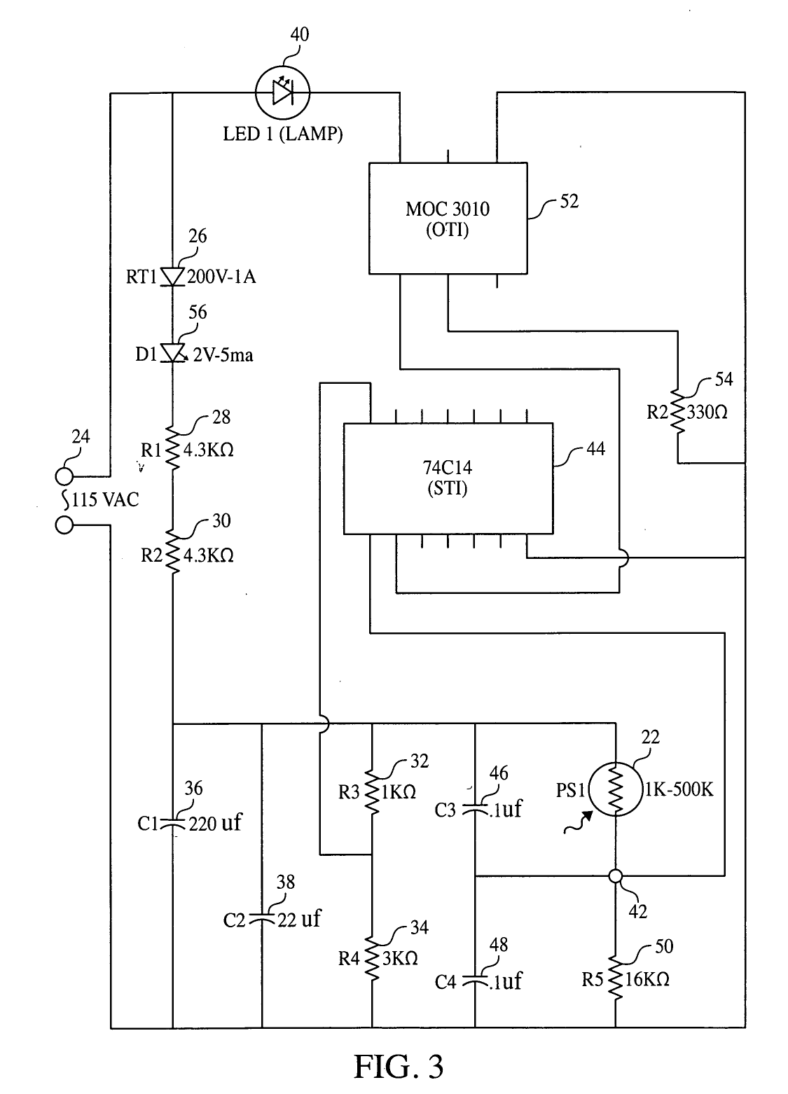

In FIGS. 2 and 3 I have provided schematic views of my night light in a manner which I felt would present the most easily understood manner of operation.

In the schematic view of FIG. 2 I have shown the various components and the proper connections without indicating the electrical values of the various components. Then, in FIG. 3 I have shown and described the various components by the electrical value of each component.

However, I am still aware, and later describe, certain components that may be positioned together within a box-like structure, as an integrated circuit component.

I show in FIG. 2 the circuitry and components in connection with a household outlet 24.

A rectifier 26 has a voltage drop of 60 VDC that turns the household current, approximately 115 VAC into a pulsating direct current of approximately 60 VDC across resistors 28, 30, 32, and 34. Resistors 28 and 30 provide voltage drops of 20 VDC, resistor 32 provides a voltage drop of 5 VDC and resistor 34 provides a voltage drop of 15 VDC. It is obvious that the power supplied to the other components of the night light must be a DC voltage, otherwise the components will not operate, or will be damaged.

The voltage across resistors 32 and 34 is 20 VDC, and the voltage across 34, which is 15 VDC, are both used to supply power to every other component in the night light.

Filter capacitors 36 and 38 in connection with resistors 32 and 34 turns the pulsating voltage across those two resistors into a pure direct current. This pure DC signal is essential for the remaining components in the night light to operate properly.

Without the capacitors 36 and 38 in the circuit, the LED lamp in the night light would oscillate or flash rapidly, remaining components in the automatic night light would be damaged or destroyed.

Connection point 42, STI(V+) of a Schmitt-trigger Inverter 44, includes the voltage drop across resistor 34, as supplied to the trigger-Inverter 44 which I consider the main component of the automatic night light circuit. The trigger-Inverter 44 would not operate correctly without connection point 44. I do not show STI(V+) in FIG. 3 because it is internally attached to STI 44,

The voltage drop of 20 VDC across resistors 32 and 34, is applied to capacitors 46 and 48. Capacitors 46 and 48 prevent voltage spiking in the circuit, which would cause the Schmitt-trigger 44 to trigger falsely, or to turn on and off, unexpectedly.

Without capacitors 46 and 48 in the circuit, a voltage spike in the household electrical outlet would cause the LED lamp 40 to flash momentarily, particularly when a light switch is turned on in the nearby room.

The photocell 22 is an apparatus made of cadmium-sulfide for sensing a light change. Thus, photocell 22 is the device that activates the Schmitt-trigger Inverter 44 to turn on or off depending upon whether light is striking the photocell 22. The photocell 22 itself is a light sensitive device that changes resistance depending upon the amount of light on the surface of the photocell 22.

If the light is more intense (at dawn), that is greater lumens, the resistance of the photocell 22 decreases. If the light is less intense (at dusk), that is lesser lumens, the resistance of the photocell 22 increases.

Resistor 50 has a fixed resistance, but the resistance across photocell 22 is variable and depends upon the light intensity upon the surface of photocell 22. The voltage drop across resistor 50 increases when light striking photocell 22 increases and the voltage drop across resistor 50 decreases when light striking photocell 22 decreases.

For example, if the voltage across photocell 22 is 10 VDC, (which occurs with less intense light), the remaining voltage across resistor 50 is 15 VDC

The sum of the voltage drop across photocell 22 and resistor 50 will always equal 20 VDC. Thus, photocell 22+resistor 50=resistor 32+resistor 34=20 VDC.

The Schmitt-trigger Inverter 44, shown as STI 44, the main component in my automatic night light, senses the voltage change across resistor 50, and this voltage will turn the Schmitt-trigger Inverter 44 on and off instantaneously. With more light striking photocell 22, the Schmitt-trigger Inverter 44 will turn off, and with less light striking photocell 22, the Schmitt-trigger Inverter 44 will turn on.

When the Schmitt-trigger Inverter 44 turns on at dusk, the output voltage of the Schmitt-trigger Inverter is approximately 10 VDC, it is now on. When the STI 44 turns off, presumably at dawn, the voltage across STI 44 is approximately 0.7 VDC.

The voltage drop of STI 44 is applied to the input of a component called an optocoupler, shown as OT1 52.

The primary purpose of OT1 52 is to take a small change in voltage, 0.7 VDC to 10 VDC, at the input of OT1 52, and control a larger voltage, for example 115 VAC to 120 VAC, at the output of OT1 52.

When the output of the STI 44 is low, the output of OT1 is also low, and OT1 52 is now off.

When the output of the STI 44 is high, OT1 52 output is also high. The output of OT1 52 is an AC voltage, equal to the voltage of the household line. This voltage is what the LED lamp 40 uses as power for operation. I chose LED 40 because it is a super-bright while light-emitting diode requiring 115 VAC to 120 VAC @15 ma for it's power.

When the output of OT1 52 is low, as at dawn, LED 40 will not light up.

When the output of OT1 52 is high, as at dusk, LED 40 will light up.

I have placed resistor 54 in line because it is a limiting resistor and will keep OT1 52 from burning up.

I have placed an LED 56 with a red diffused lens and efficiency of 2.0V-5 ma in my circuit to act as a fuse in case my automatic night light should malfunction.

As I have shown, my automatic night light is a solid state device, there are no moving parts. Solid-state devices usually last longer.

Thus, where it might be convenient, some, or, even all, of the electrical components can be placed on a small printed circuit board and attached as might be more convenient.

In FIG. 3 I have provided electrical values for all the components and have, for example, indicated OT1 52 and ST1 44 as being incorporated upon circuit boards components.

The scope of my present invention extends to the full extent indicated by the broad general meaning of the terms expressed by the appended claims.

Therefore, I claim:

1. An improved night light, comprising:
A base unit having support means adaptable for electrical attachment to an electric outlet,
A control circuit adjacent said base unit and in connection with said support means,
A light component in connection with said control circuit,
Sensor means in connection with said control circuit to be operable in response to a condition of ambient light, and
An electronic switching component in connection with said control circuit to provide rapid switching operation.

2. An improved night light as described in claim 1, wherein:
Said support means comprises a pair of metal contact members adaptable to support said base unit properly and provide proper connection between a household electric outlet and said control circuit.

3. An improved night light as described in claim 2, wherein:
Said control circuit includes circuit limiting means to convert said household current from a high AC current to a proper lower DC current for operation of electronic components including a safety fuse.

4. An improved night light as described in claim 3, wherein:
Said switching component comprises an electronic switch to be operable as a trigger unit to be capable of providing practically instantaneous switching.

5. An improved night light as described in claim 4, wherein:
Said switching component operable as a trigger unit is a component universally known as a Schmitt trigger circuit.

6. An improved night light as described in claim 5, wherein:
Said sensor means comprises a standard photocell.

7. An improved night light as described in claim 6, wherein:
Said light component comprises an LED light.

8. An improved night light as described in claim 7, wherein:
Said LED light is positionable adjacent said base unit.

9. An improved night light as described in claim 8, wherein:
Said LED is positionable upon said base unit under proper cover.

10. An improved night light as described in claim 9, wherein:
Said control circuit comprises a standard electronic circuit board positionable adjacent said base unit.

11. An improved night light as described in claim 10, wherein:
A housing component is attachable to said base unit to provide effective cover for said light component.

12. An improved night light as described in claim 11, wherein:
Said housing includes a portion thereof in attachment with said base unit.

13. An improved night light as described in claim 12, wherein:
Said housing provides two sides thereof for cover of said light component.

14. An improved night light as described in claim 13, wherein:
Said housing provides a portion thereof for effective cover of said sensor means.
